(19) United States
(12) Patent Application Publication
(10) Pub. No.: US 2026/0175828 A1
(43) Pub. Date: Jun. 25, 2026

(54) METHOD, CONTROL DEVICE AND DRIVE GROUP FOR PREVENTING UNDESIRED TRAVELLING OF A WORK MACHINE IN A WRONG DIRECTION, AND WORK MACHINE

(71) Applicant: ZF FRIEDRICHSHAFEN AG, Friedrichshafen (DE)

(72) Inventors: Andreas Rothmund, Hohentengen (DE); Matthias Madlener, Hohentengen (DE); Guilherme Ariello, Friedrichshafen (DE)

(21) Appl. No.: 19/125,752

(22) PCT Filed: Nov. 8, 2023
(86) PCT No.: PCT/EP2023/081096

§ 371 Date: Apr. 30, 2025

(30) Foreign Application Priority Data
Nov. 14, 2022 (DE) 10 2022 212 044.2

(51) Int. Cl. B60W 10/08; B60W 10/06; B60W 10/18; B60W 20/10

(52) U.S. Cl. CPC B60W 10/08; B60W 10/06; B60W 10/18; B60W 20/10

(57) ABSTRACT

A method is described for preventing undesired travelling of a work machine (14) in a wrong direction, wherein the work machine (14) has an electric machine (2) for propelling the work machine (14). A desired direction of travel (FRW) of a driver of the work machine (14) is sensed (S1) and a state variable of the work machine (14) that correlates with an actual direction of travel of the work machine is sensed (S2). Furthermore, on the basis of a comparison of the sensed desired direction of travel (FRW) and the sensed state variable of the work machine, it is identified (S3) whether the electric machine (2) is in a safety-critical state. Then, if it has been identified that a safety-critical state exists, a signal is sent (S4) to the electric machine (2) to transfer the electric machine (2) into a state not suitable for propulsion. Furthermore, a control device (4) is described, which is designed to carry out such a method. In addition, the invention relates to a drive group (6) having such a control device (4), and to a work machine (14) having such a drive group (6).

### CROSS REFERENCE TO RELATED APPLICATIONS

This application is a U.S. National Phase application under 35 U.S.C. § 371 of International Application No. PCT/EP2023/081096, filed on Nov. 8, 2023, and claims benefit to German Patent Application No. DE 10 2022 212 044.2, filed on Nov. 14, 2022. The International Application was published in German on May 23, 2024 as WO 2024/104850 A1 under PCT Article 21(2).

### FIELD

The present invention relates to a method for preventing undesired travelling of a work machine in a wrong direction, to a control device, to a drive group having such a control device, and to a work machine having such a drive group.

### BACKGROUND

Methods for controlling travelling behaviors of vehicles are known from the prior art. In this case, it is possible actively to bring about travelling behavior, e.g. active braking. Alternatively, it is possible to prevent processes, e.g. a lane change.

### SUMMARY

In an embodiment, the present disclosure provides a method for preventing undesired travelling of a work machine in a wrong direction, wherein the work machine has an electric machine for propelling the work machine. The method comprises detecting a desired direction of travel of a driver of the work machine and detecting a state variable of the work machine that correlates with an actual direction of travel of the work machine. The method further comprises determining, based on a comparison of the detected desired direction of travel and the detected state variable of the work machine, whether the electric machine is in a safety-critical state. The method further comprises, based on a determination that a safety-critical state exists, sending a signal to the electric machine to transfer the electric machine to a state unsuitable for propulsion.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic view of a work machine according to an embodiment;

FIG. 2 illustrates schematically steps of a method for preventing undesired travelling of a work machine according to FIG. 1 in a wrong direction;

FIG. 3a illustrates a time characteristic of state variables during execution of the method with the steps illustrated schematically in FIG. 2; and

FIG. 3b illustrates an alternative time characteristic of the method with the steps illustrated schematically in FIG. 2.

### DETAILED DESCRIPTION

In an aspect, the present disclosure relates to a method for preventing undesired travelling of a work machine in a wrong direction. The work machine can be an agricultural machine, a construction machine, a transport machine or an off-highway vehicle. The work machine has an electric machine for propelling the work machine. The electric machine can be supplied with electrical energy from an energy storage device, e.g. a battery, such as a lithium ion battery, in order to propel the work machine. In addition to the electric machine for propulsion, the work machine can have additional machines, such as additional electric machines, e.g. for lifting a lift frame. In addition, the work machine can have a control device which can be configured to carry out the method for preventing undesired travelling in a wrong direction. The electric machine can have an inverter, e.g. a low-voltage inverter. The undesired travelling in the wrong direction can be travelling of the work machine in a direction which was not intended by a driver of the work machine. Preventing undesired travelling can comprise stopping or preventing further undesired travelling. Furthermore, the method can comprise preventing an undesired change in direction.

The method comprises detecting a desired direction of travel of the driver of the work machine. In this case, information on a position of a travel direction switch can be acquired and sent to the control device carrying out the method. Detecting the desired direction of travel can comprise receiving information on the position of the travel direction switch. Detecting the desired direction of travel can comprise determining the desired direction of travel as a function of the information received on the position of the travel direction switch. The desired direction of travel can be forward, backward or neutral, for example.

The method further comprises detecting a state variable of the work machine that correlates with an actual direction of travel of the work machine. A state variable that correlates with the actual direction of travel of the work machine can be a rotational speed of a wheel or of a chain of the work machine, for example. The rotational speed can be negative, zero or positive. Depending on the sign of the rotational speed, the actual direction of travel of the work machine can be forward, backward or neutral, for example, wherein neutral can mean that the work machine is not moving and is stationary. Detecting the state variable can comprise receiving information on the state variable.

The method further comprises determining, on the basis of a comparison of the detected desired direction of travel and the detected state variable of the work machine, whether the electric machine is in a safety-critical state. The electric machine is in a safety-critical state, for example, if the desired direction of travel and the actual direction of travel that correlates with the state variable differ. For example, the driver may want to drive forward, while the state variable can indicate, for example, that the actual direction of travel is backward.

The method further comprises, if it has been determined that a safety-critical state exists, sending a signal to the electric machine to transfer the electric machine to a state unsuitable for propulsion. The control device for carrying out the method can be connected electronically to the electric machine and to the inverter. This enables the signal for transfer of the electric machine to the state unsuitable for propulsion to be sent to the inverter and the electric machine. In this case, a safety state enquiry can be sent by the control device carrying out the method to the electric machine or the inverter. Here, the state unsuitable for propulsion can be a safe state of the electric machine. In the state unsuitable for propulsion, provision can be made for the electric machine to be unable to produce any driving force to propel the work machine.

With the method indicated, undesired travel, e.g. undesired driving away, in the wrong direction can be safeguarded against and prevented. Travelling, e.g. driving away, of the work machine can be safety-critical since there can be people in the surroundings of the work machine. Such a method can prevent undesired travelling in the wrong direction in situations where, for example, there is a hardware or software fault in the control device and undesired travelling in the wrong direction is initiated.

According to an embodiment, the method can be characterized in that the detection of the state variable that correlates with the actual direction of travel comprises detecting a direction of motor rotation of the electric machine. This can be detected by means of sensors on the electric machine, for example. Alternatively or in addition, the direction of motor rotation can be detected by current and voltage measurements on the inverter and alternatively or in addition on the electric machine. The detected direction of motor rotation can be sent from the inverter or from the electric machine to the control device carrying out the method, wherein detection of the state variable can comprise receiving information in the form of a signal. The method can furthermore be characterized in that determination of the actual direction of travel takes place on the basis of the detected direction of motor rotation. The actual direction of travel can be determined by way of a predetermined transmission ratio as a function of the direction of motor rotation. If the motor is rotating in a first direction, the actual direction of travel can be forward, for example. If the motor is rotating in a second direction, opposite to the first direction, the actual direction of travel can be backward. If the direction of motor rotation is zero, the actual direction of travel can be neutral and the work machine can be stationary. The method can furthermore be characterized in that the determination of a safety-critical state takes place if the determined actual direction of travel is different from the detected desired direction of travel. For example, the actual direction of travel can be in a first direction of travel, e.g. forward, and the desired direction of travel can be in a second direction of travel opposite to the first direction of travel, e.g. backward.

It is thereby provided to indicate a method which can determine an actual direction of travel by means of information in respect of the direction of motor rotation and, by means of this actual direction of travel, can carry out determination of the safety-critical state. The signal can thus be sent to the electric machine for the transfer of the electric machine to a state unsuitable for propulsion on the basis of an easily measured state variable of the electric machine, the direction of motor rotation.

According to an embodiment, the method can be characterized in that the detection of the state variable that correlates with the actual direction of travel comprises detecting a motor speed of the electric machine. Detection of the motor speed of the electric machine can comprise receiving a signal with information on the motor speed of the electric machine from the inverter and alternatively or in addition from the electric machine. The motor speed can be detected by means of sensors on the electric machine. Alternatively or in addition, the motor speed can be determined by current and voltage measurements. Detection of the motor speed can also include detection of the direction of motor rotation. Determination of the actual direction of travel can thus take place on the basis of the detected motor speed. The method can furthermore be characterized in that the determination of a safety-critical state takes place if the detected motor speed is within a parameter range around a motor speed corresponding to a stationary state of the work machine. The motor speed corresponding to a stationary state of the work machine can be zero, for example. The parameter range can include positive and negative motor speeds, with the parameter range being arranged symmetrically around a motor speed of zero, for example. Alternatively or in addition, the determination of a safety-critical state can take place if the detected motor speed changes from a value which corresponds to a stationary state of the work machine. For example, the determination of a safety-critical state can take place if the motor speed changes from a value of zero to a value unequal to zero.

By means of the method shown, a safety-critical state can be determined if the motor speed is in a range around a motor speed corresponding to the stationary state of the work machine. It is thus made possible, at low travelling speeds, that is to say, for example, when driving the work machine away, to provide a functionality of the method to prevent driving away in the wrong direction. If the determination of the safety-critical state takes place when the detected motor speed changes from a value of zero to a value unequal to zero, the function can be triggered and determine a safety-critical state only when driving away from the stationary state, and can not be triggered, i.e. determine a safety-critical state, for example, if the work machine was already moving before the start of the method.

According to an embodiment, the method can furthermore be characterized in that determination of a gradient of the motor speed can take place on the basis of the detected motor speed. In this case, the control device can be configured to carry out the determination of the gradient of the motor speed. Furthermore, the method can be characterized in that the determination of a safety-critical state takes place if there is a change in the desired direction of travel and a comparison of the determined gradient of the motor speed with a minimum gradient shows that the determined gradient is greater. Here, the minimum gradient can be a predetermined minimum gradient and can be stored in the control device. The minimum gradient can be parameterizable during the coding of the control device. The changing of the desired direction of travel can be present, for example, if the driver changes the position of the travel direction switch from a first direction, e.g. forward, to a second direction, e.g. backward. Comparison of the determined gradient with the minimum gradient can be carried out by the control device and be part of the determination of the safety-critical state or can take place shortly before this.

By means of the method, a reversal, i.e. a changed desired direction of travel of the driver, can be taken into account. The safety-critical state is not determined, for example, in the case where there is a reversal and the gradient of the motor speed is below the minimum gradient. In this case, there can be a desire for the desired direction of travel and the actual direction of travel to be different. This can contribute to increasing the robustness of the method in that no transfer of the electric machine to a state unsuitable for propulsion takes place if a desired reversal by the driver takes place.

According to an embodiment, the method can be characterized in that acquisition of information on an operating mode of the electric machine takes place. Here, acquisition can comprise receiving information on the operating mode from the inverter and alternatively or in addition from the electric machine. The operating mode can comprise information in respect of a torque provided by the electric machine for the propulsion of the work machine. For example, the operating mode can be one of a generator mode, a motor mode and a torque-free mode. In the generator mode, the electric machine can be operable as a generator and there can be a negative torque, wherein torque is transmitted to the electric machine, e.g. via the drivetrain. In the motor mode, there can be a positive torque and, in the motor mode, the electric machine can be configured to provide torque for the propulsion of the work machine. In the torque-free mode, the torque which is transmitted from or to the electric machine can be less than one or more threshold torques. The method can furthermore be characterized in that the determination of a safety-critical state takes place if the electric machine is in the motor mode. It is thus not possible for determination of the safety-critical state to take place if the electric machine is in the generator mode or in the torque-free mode, for example. Accordingly, the safety-critical state can be determined when torque is actively being transmitted from the electric machine for the propulsion of the work machine.

The method can thus take account of an operating mode of the electric machine. In this context, whether active driving away or merely rolling away of the work machine is taking place can be taken into account. In the case of rolling away, a torque-free state of the electric machine can be present, for example, and, in such a case, the safety-critical state can not be determined, for example. It is thereby furthermore made possible to increase the robustness of the method in respect of incorrect shutdowns. Furthermore, a low-voltage inverter can be used in combination with a control device which can carry out the method. With such low-voltage inverters, it can be the case that precise information on current or past torques at the electric machine is not available. The only information on the torque that can be available is whether this is above or below certain threshold torques, and this can be sent to the control device in the form of the operating mode, for example, in order to carry out the method.

According to an embodiment, the method can be characterized in that the determination of a safety-critical state takes place if the safety-critical state exists for the duration of a fault tolerance time. The fault tolerance time can be several milliseconds, several hundredths or tenths of a second or a few seconds, for example. The fault tolerance time can be parameterizable and alternatively or in addition codable in the control device which can carry out the method. Thus, for example, determination of a safety-critical state can take place if, for the duration of a fault tolerance time, both the operating mode of the electric machine is in the motor mode and the desired direction of travel and the actual direction of travel are different.

The provision of the fault tolerance time furthermore enables the method to be more robust in respect of undesired incorrect shutdowns. Thus, if the prerequisites for the determination of the safety-critical state are present for less than the duration of the fault tolerance time, the safety-critical state can not to be determined, for example.

According to an embodiment, the method can be characterized in that detection of a travel requirement of the driver takes place. Detection can comprise receiving a signal on a position of one or more pedals of the work machine. The travel requirement can be, for example, that the driver is pressing the accelerator pedal halfway down. The method can furthermore be characterized in that determination of a desired travelling speed takes place as a function of the detected travel requirement. For example, the control device can be configured to carry out this determination. With an accelerator pedal pressed halfway down, for example, the value of the desired travelling speed can be determined as half the maximum possible speed of the work machine. The method can furthermore be characterized in that the determination of the safety-critical state takes place if a comparison of the desired travelling speed with a minimum speed shows that the desired travelling speed is greater. The step of comparing the desired travelling speed with the minimum speed can be part of the determination of the safety-critical state and can be carried out by the control device. The minimum speed can be 3 or 5 km/h, for example.

With such a method, the safety-critical state can be determined if the driver actively wants to drive up to a desired travelling speed which exceeds the minimum speed, i.e. wants an active driveaway of the work machine. The method can furthermore be more robust as a result. In this way, the determination of the safety-critical state can not take place if the driver is not pressing a pedal to request a travelling speed, for example. Here, it is provided, simply by changing the position of the travel direction switch to a forward direction, for example, and not simultaneously pressing the accelerator pedal, to prevent determination of the safety-critical state. In this case, there is no incorrect shutdown of the electric machine into a state unsuitable for propulsion.

An aspect of the present disclosure relates to a control device which is configured to carry out a method for controlling a work machine according to an embodiment of the first aspect of the present disclosure. The control device can comprise interfaces for receiving and sending signals from and to sensors, actuators and other control devices.

An aspect of the present disclosure relates to a drive group having an electric machine and a control device according to an aspect of the present disclosure. The electric machine can have a low-voltage inverter.

An aspect of the present disclosure relates to a work machine having a vehicle control device, a pedal, a travel direction switch, and a drive group according to the an aspect of the present disclosure. Alternatively, the work machine has more than one pedal. For example, it has a brake pedal and an accelerator pedal. The pedal and the travel direction switch can be connected electrically to the vehicle control device, which in turn can be connected electrically to the drive group and, at the same time, to the control device of the drive group. Signals from the pedal and from the travel direction switch can be sent to the control device via the vehicle control device. In the control device, steps of the method for preventing undesired travelling of the work machine in the wrong direction can be carried out. Furthermore, the work machine can be configured to transfer the electric machine to a state unsuitable for propulsion. The work machine can be a construction machine, agricultural machine, transport machine or an off-highway vehicle.

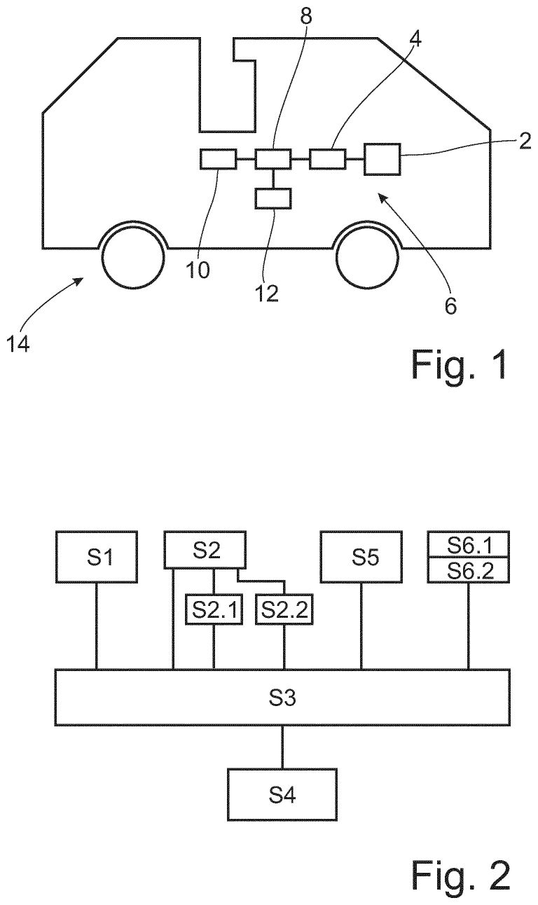

FIG. 1 shows schematically a work machine 14 according to an embodiment of the present disclosure. The work machine 14 has a drive group 6 of the present disclosure. The drive group 6 has a control device 4 and an electric machine 2 as well as a low-voltage inverter. The electric machine 2 is connected electrically and electronically to the control device 4 via the low-voltage inverter. Furthermore, the work machine 14 has a vehicle control device 8 connected electronically to the control device 4. The vehicle control device 8 is connected electrically to a pedal 10 and to a travel direction switch 12. The vehicle control device 8 is configured to receive and process signals from the pedal 10 and from the travel direction switch 12, and to send signals to the control device 4. The electric machine 2 and the low-voltage inverter are configured to send electric signals to the control device 4. The control device 4 is configured to carry out a method for preventing undesired travelling of the work machine 14 in accordance with the steps shown schematically in FIG. 2.

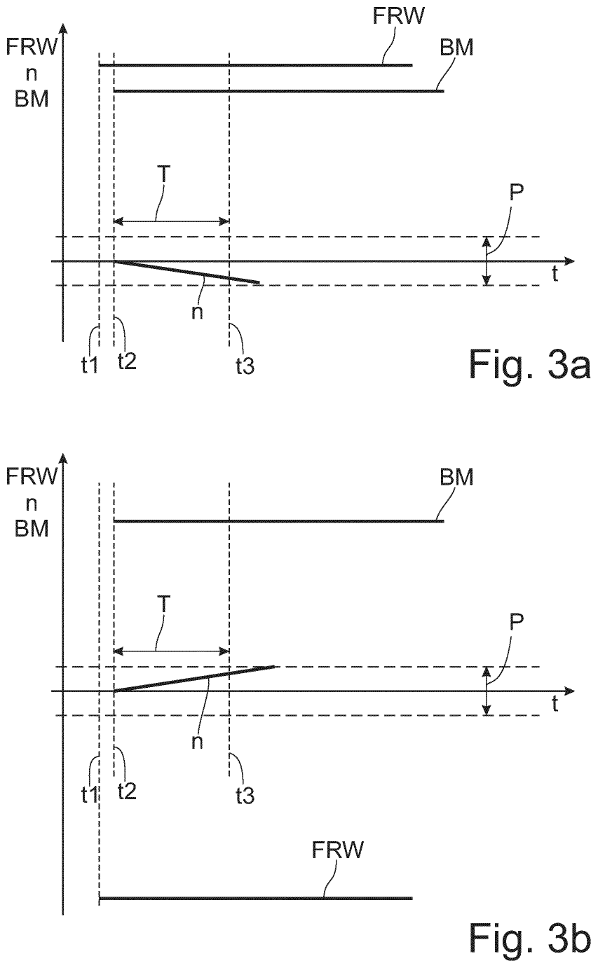

FIG. 3a shows, by way of example, the time variation of state variables during the execution of the method for preventing undesired travelling of the work machine 14 in the wrong direction. In this context, a desired direction of travel FRW, a motor speed n and an operating mode BM are plotted as state variables against time t. At a time t1, the desired direction of travel FRW changes to forward. In an alternative case, shown in FIG. 3b, the desired direction of travel FRW changes to backward at time t1. This is accomplished by the driver changing the position of the travel direction switch to a position corresponding to the forward direction or, alternatively, the backward direction. Detection S1 of the desired direction of travel FRW of the driver of the work machine 14 takes place. At a time t2, the operating mode BM of the electric machine 2 changes to the motor mode. This takes place in the cases shown in FIGS. 3a and 3b. In the motor mode, a torque for propelling the work machine 14 is provided by the electric machine 2. This is accomplished by activation of the inverter by the control device 4 and supplying energy to the electric machine 2 from an energy storage device. In addition, acquisition S5 of information on the operating mode BM takes place. The operating mode BM can be determinable by the inverter and can be sent in the form of a signal to the control device 4.

As a result of the electric machine 2 being activated to propel the work machine 14, the work machine 14 is propelled. Detection S2 of the motor speed n as a state variable takes place. Here, the magnitude of the motor speed n increases with time t. In FIG. 3a, the value of the motor speed n is falling. In the alternative situation shown in FIG. 3b, the value of the motor speed n is rising, and, in comparison with the case shown in FIG. 3a, the sign is positive. In other words, the motor speed n in the cases shown in FIGS. 3a and 3b differs in the sign.

In a detection step S6.1, detection of a travel requirement of the driver furthermore takes place. The driver can, for example, actuate the pedal 10, wherein the pedal 10 sends information on this actuation to the vehicle control device 8 and also to the control device 4. In a step S6.2, determination of a desired travelling speed takes place as a function of the detected travel requirement. Thus, in the case of a pedal pressed down by 30%, for example, a travelling speed of 30% of the maximum speed is determined.

The method furthermore has a step of determining S3 a safety-critical state of the electric machine 2. A safety-critical state is determined if, within a fault tolerance time T, which runs from time t2 to a time t3, the desired direction of travel FRW corresponds to a first direction and the actual direction of travel corresponds to a second direction opposite to the first direction. In FIG. 3a, the desired direction of travel FRW is positive, corresponding to a desired direction of travel FRW in the forward direction. In FIG. 3b, in contrast, the desired direction of travel FRW is negative, that is to say a desired direction of travel FRW in the backward direction. Determination S2.1 of the actual direction of travel takes place on the basis of the detected motor speed n. Thus, the negative motor speed n in FIG. 3a corresponds to an actual direction of travel in the backward direction, and a positive motor speed n, as shown in FIG. 3b, corresponds to a forward direction. At the same time, there must be a motor mode available as the operating mode BM of the electric machine 2 in order to determine S3 the safety-critical state for the fault tolerance time T. Moreover, the detected motor speed n must be within a parameter range P around a motor speed n that corresponds to a stationary state of the work machine 14. In the cases shown in FIGS. 3a and 3b, the stationary state is defined by a motor speed n equal to zero. In addition, determination S3.2 of a gradient of the motor speed n takes place. Determination S3 of the safety-critical state takes place if the gradient is greater than a minimum gradient. Here, the minimum gradient can be a predetermined minimum gradient and can be stored in the control device 4. If all these prerequisites are present, it is determined at time t3 that a safety-critical state exists.

Furthermore, sending S4 of a signal to the electric machine 2 takes place, and at the same time to the low-voltage inverter, in order to transfer the electric machine 2 to a state unsuitable for propulsion. This state unsuitable for propulsion is achieved by sending a safety state enquiry from the control device 4 to the inverter and also to the electric machine 2. After the transfer of the electric machine 2 to a state unsuitable for propulsion, the electric machine 2 is torque-free in respect of the propulsion of the work machine 14. There is thus no transfer of power from the electric machine 2 to propel the working machine 14.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

REFERENCE SIGNS

| | |
|---|---|
| 2 | electric machine |
| 4 | control device |
| 6 | drive group |
| 8 | vehicle control device |
| 10 | pedal |
| 12 | travel direction switch |
| 14 | work machine |
| S1 | (step) detection of a desired direction of travel |
| S2 | (step) detection of a state variable |
| S2.1 | (step) determination of an actual direction of travel |
| S2.2 | (step) determination of a gradient of the motor speed |
| S3 | (step) determination of a safety-critical state |
| S4 | (step) sending a signal for the transfer of the electric machine |
| | to a state unsuitable for propulsion |
| S5 | (step) acquisition of information on an operating mode |
| S6.1 | (step) detection of a travel requirement |
| S6.2 | (step) determination of a desired travelling speed |
| BM | (value) operating mode |
| FRW | (value) desired direction of travel |
| n | (value) motor speed |
| P | parameter range |
| T | fault tolerance time |
| t | time |
| t1 | (time) change of the desired direction of travel |
| t2 | (time) change of the operating mode |
| t3 | (time) reaching of the safety-critical state |

1. A method for preventing undesired travelling of a work machine in a wrong direction, wherein the work machine has an electric machine for propelling the work machine, the method comprising:
detecting a desired direction of travel of a driver of the work machine;
detecting a state variable of the work machine that correlates with an actual direction of travel of the work machine;
determining, based on a comparison of the detected desired direction of travel and the detected state variable of the work machine, whether the electric machine is in a safety-critical state; and,
based on a determination that a safety-critical state exists, sending a signal to the electric machine to transfer the electric machine to a state unsuitable for propulsion.

2. The method as claimed in claim 1, wherein detecting the state variable that correlates with the actual direction of travel comprises detecting a direction of motor rotation of the electric machine,
wherein a determination of the actual direction of travel takes place based on the detected direction of motor rotation, and
wherein the determination of the existence of the safety-critical state takes place based on the determined actual direction of travel being different from the detected desired direction of travel.

3. The method as claimed in claim 1, wherein detecting the state variable that correlates with the actual direction of travel comprises detecting a motor speed of the electric machine, and
wherein the determination of the existence of the safety-critical state takes place based on the detected motor speed being within a parameter range around a motor speed corresponding to a stationary state of the work machine.

4. The method as claimed in claim 3, comprising determining a gradient of the motor speed based on the detected motor speed, and
wherein the determination of the existence of the safety-critical state takes place based on a change in the desired direction of travel and a comparison of the determined gradient of the motor speed with a minimum gradient showing that the determined gradient is greater than the minimum gradient.

5. The method as claimed in claim 1, comprising acquiring information on an operating mode of the electric machine, and wherein the determination of the existence of the safety-critical state takes place based on the electric machine being in a motor mode.

6. The method as claimed in claim 1, wherein the determination of the existence of the safety-critical state takes place based on the safety-critical state existing for a duration of a fault tolerance time.

7. The method as claimed in claim 1, comprising detecting a travel requirement of the driver; and
determining a desired travelling speed as a function of the detected travel requirement,
wherein the determination of the existence of the safety-critical state takes place based on a comparison of the desired travelling speed with a minimum speed showing that the desired travelling speed is greater than the minimum speed.

8. A control device configured to carry out the method as claimed in claim 1.

9. A drive group comprising:
an electric machine; and
the control device as claimed in claim 8.

10. A work machine, comprising:
a vehicle control device;
a pedal;
a travel direction switch; and
the drive group as claimed in claim 9.
